(19) United States
(12) Patent Application Publication
(10) Pub. No.: US 2015/0354765 A1
(43) Pub. Date: Dec. 10, 2015

(54) LIGHTING ASSEMBLY

(71) Applicant: RAVES EQUIPMENT COMPANY, Auburn Hills, MI (US)

(72) Inventors: Wael M. Hannawa, West Bloomfield, MI (US); Ramize Sheena, West Bloomfield, MI (US)

(21) Appl. No.: 14/762,059

(22) PCT Filed: Jan. 21, 2014
(86) PCT No.: PCT/US2014/012223

§ 371 Date: Jul. 20, 2015

Related U.S. Application Data
(60) Provisional application No. 61/754,053, filed on Jan. 18, 2013.

(51) Int. Cl. F21S 4/00; F21V 33/00; F21V 23/00; F21V 21/005

(52) U.S. Cl. CPC F21S 4/008; F21V 21/005; F21V 33/0044; F21V 23/005

(57) ABSTRACT

A modular track light emitting diode (LED) lighting assembly is provided for improved product lighting in display cases, including refrigeration applications. The modular track LED lighting assembly has a series of LED, including one or more flat LED arranged at an angle to form a lighting spine. In a specific inventive embodiment, the one or more flat LED are arranged at a forty five degree angle. Embodiments of the modular track LED lighting assembly may be configured with a single sided series of light sources or single lighting spine for installation on corners or shelves, or with a double sided series of light sources or lighting spines for mounting on mullions between doors of a display cabinet. The lighting assembly may be powered via battery, or via an alternating current (AC) source that is converted to a direct current (DC) voltage.

### RELATED APPLICATIONS

This application claims priority benefit of US Provisional Application Ser. No. 61/754,053 filed Jan. 18, 2013; the contents of which are hereby incorporated by reference.

### FIELD OF THE INVENTION

The present invention in general relates to the field of lighting and in particular to a lighting assembly suitable for use in display cases.

### BACKGROUND OF THE INVENTION

Commercial refrigerators and refrigerated display cases (coolers and freezers) are used in markets, food-vending operations, liquor stores for the preservation of freshness and attractive display of product to the customer. Typically, commercial display cases have frames defining a rectangular opening for the case which is accessed through sliding doors or swing doors having large areas of multi-layered glazing to permit the customer to see, select and access the refrigerated product easily, while preventing heat transfer into the refrigerated space. The display case frame includes an upper frame member, a lower frame member, two laterally spaced side frame members extending vertically between the upper and the lower frame members, and one or more mullions which extend vertically between the upper frame member and the lower frame member and connected thereto. The mullion provides support for the cabinet frame, associated doors, and also provides a sealing surface against which portions of the door assemblies engage and seal for effective sealing of the refrigerated cabinet. Typically, mullions are also equipped with electrical conduits for delivering electrical power to anti-condensation devices for the door assemblies and for a fluorescent lighting fixture associated with the mullion.

Conventional refrigerated display cases typically include a fluorescent light source to illuminate the product display area. Some refrigerated display cases include fluorescent light sources coupled to a canopy of the refrigerated display cases to direct light generally downward onto the food product in the product display area. These refrigerated display cases also may include fluorescent light sources attached to shelves in the product display area. Generally, the fluorescent light sources used in conventional refrigerated merchandisers are relatively large, and can reduce the amount of space in the refrigerated merchandiser that can be allocated to displaying food product. Fluorescent light sources also generate heat which causes the refrigeration unit to work harder and consume more energy.

Furthermore, the effectiveness of fluorescent light sources is dependent on the temperature of the application where the fluorescent light sources are used. In colder temperature conditions, the fluorescent light source has less light output than in application of the fluorescent light source in warmer temperature conditions. As a result, fluorescent light sources within the refrigerated display cases have substantially reduced effective illumination of the products within the product display area. Additionally, at lower operating temperatures initiating the required arc to illuminate a fluorescent tube is difficult.

Known lighting assemblies often also suffer from a number of problems when it comes to lighting display cases including issues pertaining to efficiency, lighting uniformity, consumer appeal, customization, and maintenance. Lighting assemblies often allow light to escape the display case and bleed out into the external environment. However, this escaping light could be put to better use lighting the item(s) on display, whereby less powerful and/or or fewer light sources could be employed. Further, lighting assemblies generally do not uniformly light a display case. For example, such assemblies generally fail to direct enough light to the center of a display case, resulting in much higher luminance in front of a mullion, as compared to the center of the display case. However, uniform luminance is preferable as it makes more efficient use of the available luminance and may allow fewer light sources and/or less powerful light sources.

Recently, fluorescent light sources have begun to be phased out in favor light emitting diodes (LED) technology. Fluorescent tubes are relatively inefficient by comparison to LEDs, since fluorescent tubes produce more heat than LEDs and LEDs provide more control over the direction of light provided. Fluorescent tubes do not have nearly as long an operating life as typical LED.

Thus, there exists a need for modular track LED lighting that provides for improved product lighting in display cases, including refrigeration applications.

### SUMMARY OF THE INVENTION

A modular track lighting assembly for display cases is provided that includes an elongated support structure that encloses a printed circuit board; one or more lighting spines supported at an angle by the elongated support structure, where the lighting spines face away from each other; one or more light emitting diodes (LED) individually mounted at a second angle on the one or more lighting spines; a set of mounting brackets joined to the elongated support; one or more lenses enclosing the one or more lighting spines; a pair of end caps at opposing ends of the assembly that seal the assembly; and wherein the printed circuit board is in electrical communication with the lighting spines.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings wherein like reference numerals refer to like parts throughout the several views, and in which:

FIG. 1 is an exploded perspective view of an embodiment of a double sided modular lighting assembly;

FIG. 2A is a is a plan view of the embodiment of the double sided modular lighting assembly of FIG. 1;

FIG. 2B is a plan view of the embodiment of one of the end caps of FIG. 1;

FIG. 3 is an exploded perspective view of an embodiment of a single sided modular lighting assembly;

FIG. 4A is a is a plan view of the embodiment of the single sided modular lighting assembly of FIG. 3;

FIG. 4B is a plan view of the embodiment of one of the end caps of FIG. 3;

FIG. 5 is top sectional view of LEDs arranged on a lighting spine of the double sided modular lighting assembly of FIG. 1;

FIG. 6 is a rear partial view of the double sided modular lighting assembly of FIG. 1 illustrating one of the mounting brackets; and

FIG. 7 is a plan view of a commercial refrigeration display case.

### DESCRIPTION OF THE INVENTION

The present invention has utility as a modular track light emitting diode (LED) lighting assembly that provides for improved product lighting in display cases, including refrigeration applications. Embodiments of the modular track LED lighting assembly have a series of LED, including one or more flat LED arranged at an angle to form a lighting spine. In a specific inventive embodiment, the one or more flat LED are arranged at a forty five degree angle. Embodiments of the modular track LED lighting assembly may be configured with a single sided series of light sources or single lighting spine for installation on corners or shelves, or with a double sided series of light sources or lighting spines for mounting on mullions between doors of a display cabinet. Embodiments of the lighting assembly may be powered via battery, or via an alternating current (AC) source that is converted to a direct current (DC) voltage.

It is to be understood that in instances where a range of values are provided that the range is intended to encompass not only the end point values of the range but also intermediate values of the range as explicitly being included within the range and varying by the last significant figure of the range. By way of example, a recited range of from 1 to 4 is intended to include 1-2, 1-3, 2-4, 3-4, and 1-4.

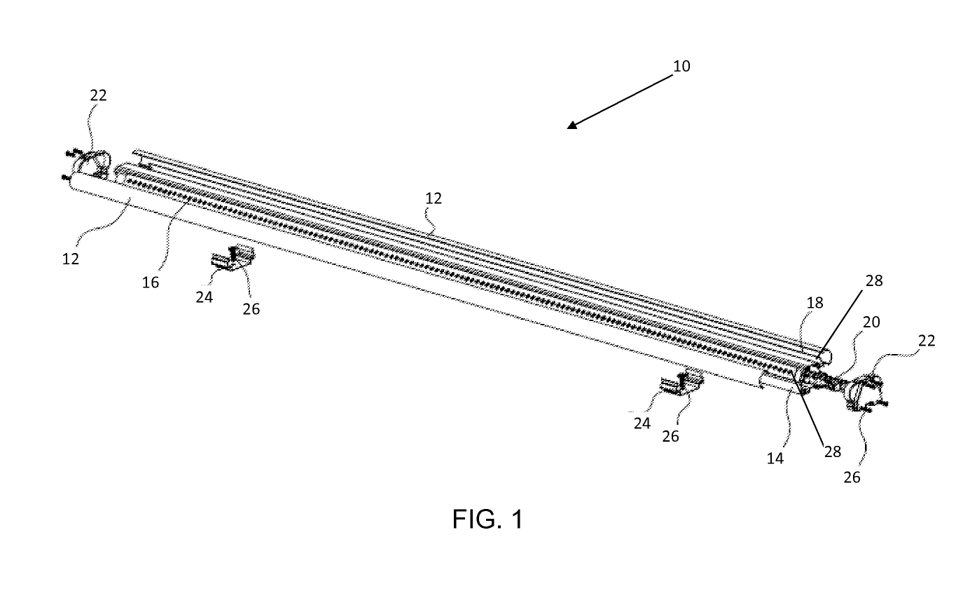

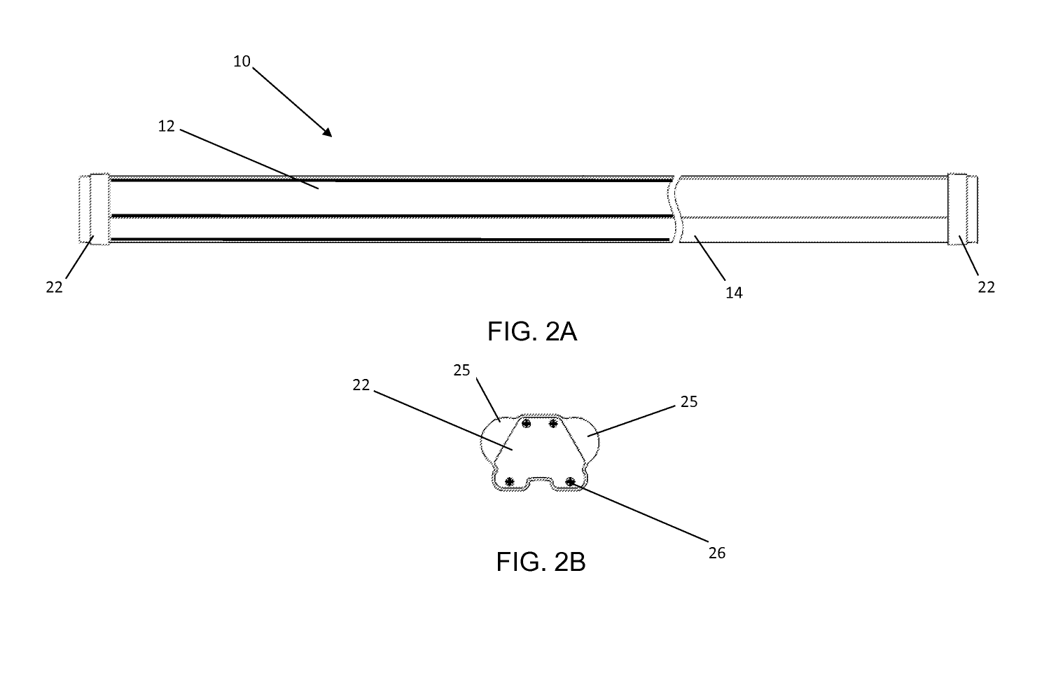

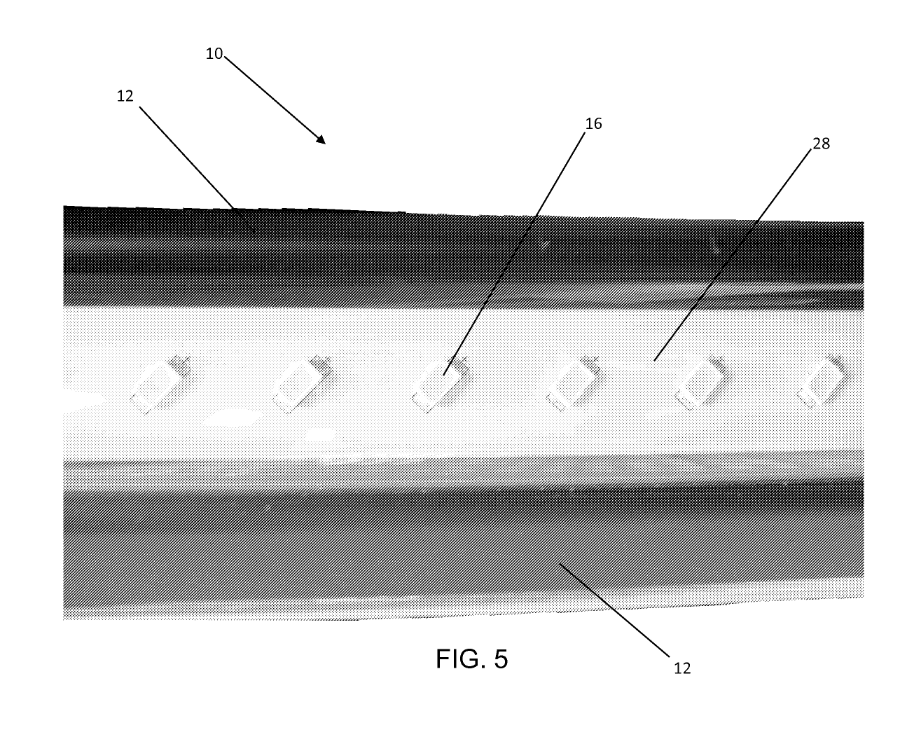

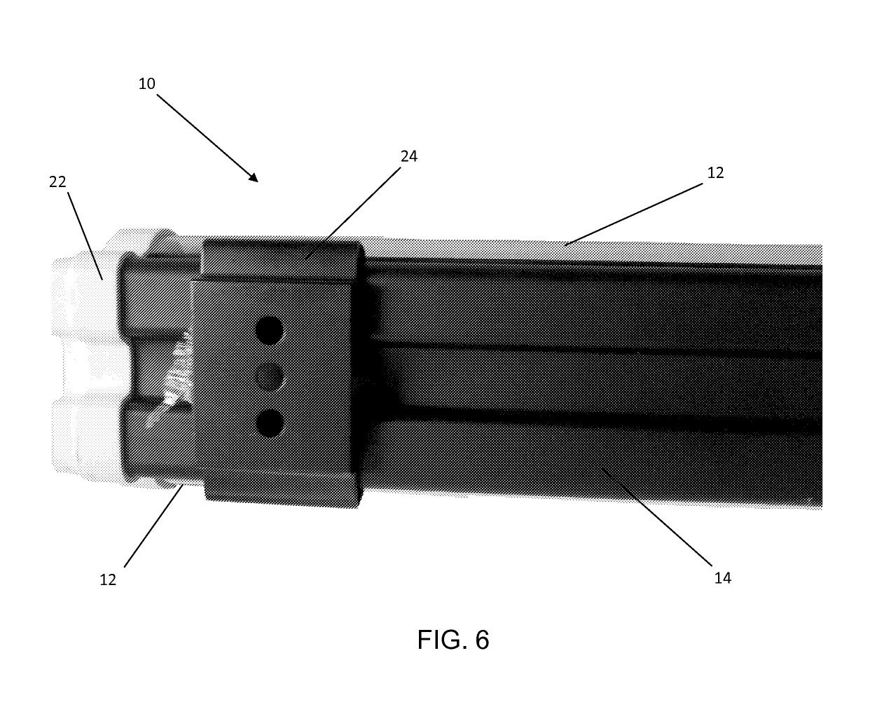

With reference to the attached figures, an inventive modular track double sided LED lighting assembly is depicted generally at 10 in FIG. 1. The modular track double sided lighting assembly 10 is formed from with an elongated support structure 14 that encloses a printed circuit board 20. The elongated support structure 14 may be made of metal, plastic, or a composite material. The printed circuit board 20 distributes power to lighting spines 28 that is optionally supplied by on-board batteries, or is configured with an AC to DC converter. The lighting spines 28 are supported at an angle between thirty and sixty degrees by the elongated support structure 14, where the lighting spines 28 face away from each other. In an embodiment, the lighting spines 28 are supported at a forty five degree angle by the elongated support structure 14. The lighting spines 28 have one or more LEDs 16 mounted to the lighting spines 28. In a specific inventive embodiment, the LEDs 16 are mounted at a forty five degree angle as shown in FIG. 5. Lenses 12 cover and seal the lighting spines 28. The lenses 12 may be clear, colored, or opaque. The lenses 12 may have a curved or straight surface. The lighting assembly 10 has end caps 22 that are joined to the assembly 10 with fasteners 26, and the end caps 22 act to seal the assembly 10. Mounting brackets 24 attached to the lighting assembly 10 with fastener 26 are used to secure the lighting assembly 10 to a mullion. FIG. 2A is a is a side plan view of the embodiment of the double sided modular lighting assembly of FIG. 1, and FIG. 2B is a front plan view of the embodiment of one of the end caps 22 that shows the curved areas 25 that accommodate the two curved lenses 12 of the double sided LED lighting assembly 10. FIG. 6 shows a rear sectional view of the lighting assembly 10 that shows the rear portion of the elongated support structure 14 with the end cap 22 and mounting bracket 14.

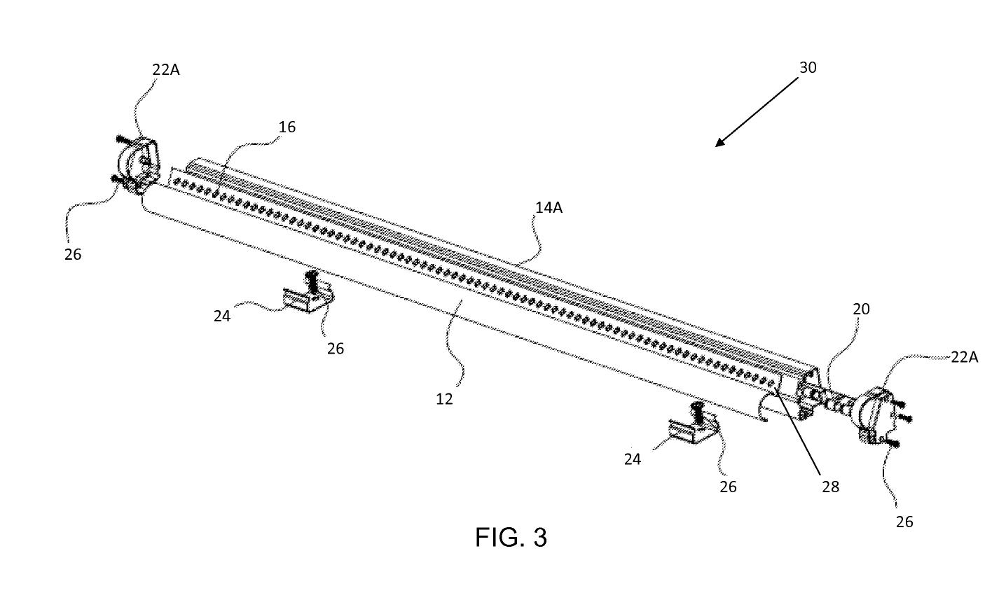

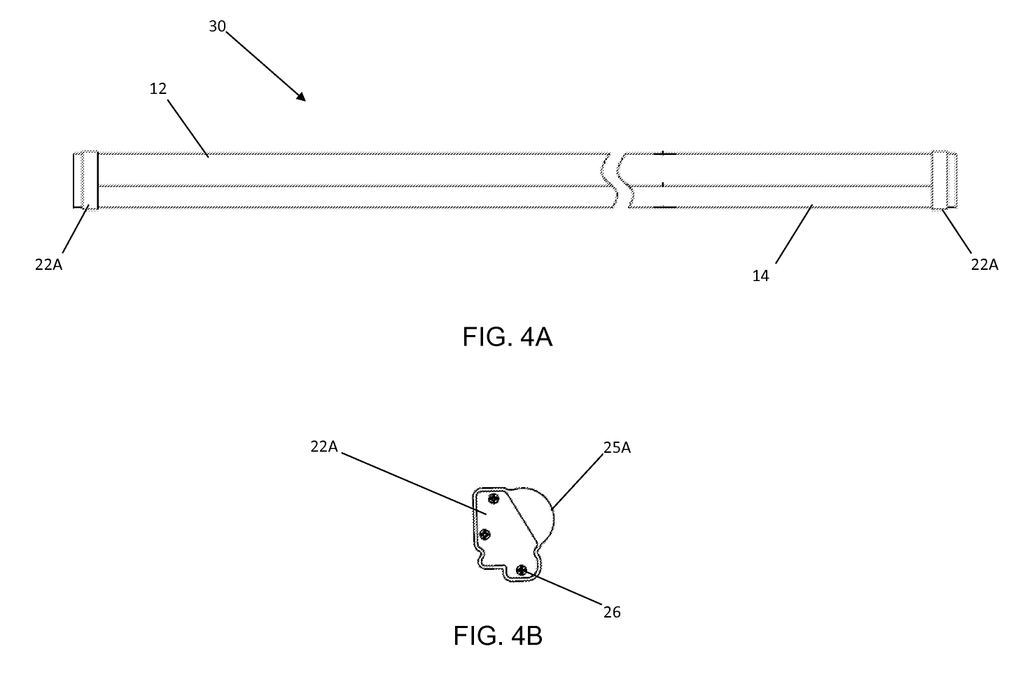

FIG. 3 is an exploded perspective view of an embodiment of a single sided modular lighting assembly 30. The single sided modular lighting assembly 30 is formed with an elongated support structure 14A that encloses the printed circuit board 20. The elongated support structure may be made of metal, plastic, or a composite material. The printed circuit board 20 distributes power to a single lighting spine 28 that is optionally supplied by on board batteries, or is configured with an AC to DC converter. The single lighting spine 28 is supported at an angle between thirty and sixty degrees by elongated support structure 14A. In an embodiment, the lighting spine 28 is supported at a forty five degree angle by the elongated support structure 14A. The lighting spine 28 has one or more LEDs 16 mounted to the lighting spine 28. In an embodiment the LEDs 16 are mounted at an angle of between 35 and 60 degrees, as shown in FIG. 5 for the specific example of a 45 degree angle. A single lens 12 covers and seals the lighting spine 28. The lens 12 may be clear, colored, or opaque. The lens 12 may have a curved or straight surface. The lighting assembly 30 has end caps 22A that are joined to the assembly 30 with fasteners 26, and the end caps 22A act to seal the assembly 30. Mounting brackets 24 attached to the lighting assembly 30 with fastener 26 are used to secure the lighting assembly 30 to a mullion. FIG. 4A is a is a side plan view of the embodiment of the single sided modular lighting assembly of FIG. 3, and FIG. 4B is a front plan view of the embodiment of one of the end caps 22A that shows the single curved area 25A that accommodate the single curved lens 12 of the single sided LED lighting assembly 30.

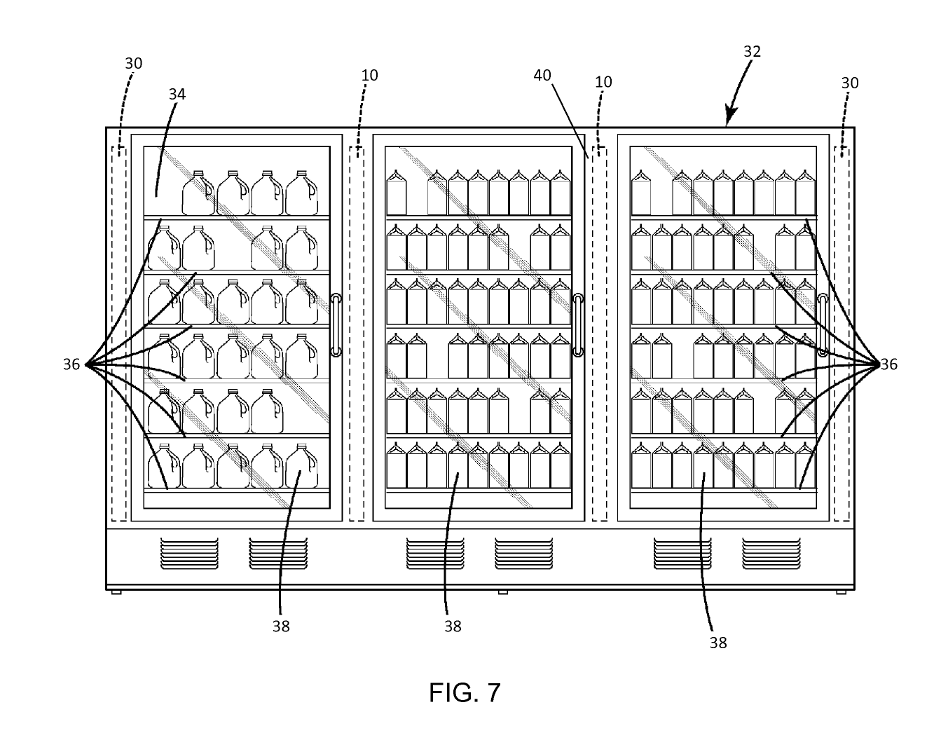

FIG. 7 is a plan view of a commercial refrigeration display case 32 enclosed by window doors 34 with shelving 36 for display of products 38. Single sided modular lighting assembly 30 is positioned on the ends of the display case 32, and double sided lighting assembly 10 are positioned on the mullions 40.

The foregoing description is illustrative of particular embodiments of the invention, but is not meant to be a limitation upon the practice thereof. The following claims, including all equivalents thereof, are intended to define the scope of the invention.

1. A modular track lighting assembly for display cases comprising:
an elongated support structure that encloses a printed circuit board; one or more lighting spines supported at an angle by said elongated support structure, where the lighting spines face away from each other;
one or more light emitting diodes (LED) individually mounted at a second angle on said one or more lighting spines;
a set of mounting brackets joined to said elongated support;
one or more lenses enclosing said one or more lighting spines;
a pair of end caps at opposing ends of said modular track lighting assembly that seal said assembly; and
wherein said printed circuit board is in electrical communication with said lighting spines.

2. The modular track lighting assembly of claim 1 wherein said elongated support structure is made of metal, plastic, or a composite material.

3. The modular track lighting assembly of claim 1 wherein said printed circuit board distributes power to said one or more lighting spines where the power is supplied by on-board batteries.

4. The modular track lighting assembly of claim 1 wherein said printed circuit board distributes power to said lighting spines where the power is supplied by an AC to DC converter.

5. The modular track lighting assembly of claim 1 wherein said lighting spines are supported at an angle of between thirty and sixty degrees by said elongated support structure.

6. The modular track lighting assembly of claim 1 wherein said lighting spines are supported at an angle of thirty five to sixty degrees by said elongated support structure.

7. The modular track lighting assembly of claim 1 wherein said one or more LED are flat LED.

8. The modular track lighting assembly of claim 1 wherein said second angle is 45 degrees.

9. The modular track lighting assembly of claim 1 wherein said one or more lenses are clear, colored, or opaque.

10. The modular track lighting assembly of claim 1 wherein said one or more lenses are curved or straight surfaces.

11. The modular track lighting assembly of claim 1 wherein said display cases are refrigeration units.

12. The modular track lighting assembly of claim 1 configured as a single sided series of light sources comprising a single lighting spine of said one or more lighting spines for installation on corners or shelves of said display cases.

13. The modular track lighting assembly of claim 1 configured as a double sided series of light sources comprising two lighting spines of said one or more lighting spines each supported at an opposing angle by said elongated support structure, where the lighting spines face away from each other; and
wherein said double sided series of light sources is designed for mounting on mullions of said display cases.
